(19) United States
(12) Patent Application Publication
(10) Pub. No.: US 2025/0334156 A1
(43) Pub. Date: Oct. 30, 2025

(54) DETERMINING A CLUTCH TEMPERATURE OF A VEHICLE CLUTCH BY MEANS OF A NEURAL NETWORK

(71) Applicant: ZF Friedrichshafen AG, Friedrichshafen (DE)

(72) Inventors: Markus Birk, Mittelbiberach (DE); Steffen Biel, Friedrichshafen (DE); Thomas Hodrius, Weiler-Simmerberg (DE)

(73) Assignee: ZF Friedrichshafen AG, Friedrichshafen (DE)

(21) Appl. No.: 18/871,032

(22) PCT Filed: May 25, 2023
(86) PCT No.: PCT/EP2023/064028

§ 371 Date: Dec. 2, 2024

(30) Foreign Application Priority Data
Jun. 2, 2022 (DE) 10 2022 205 677.9

(51) Int. Cl. F16D 48/06

(52) U.S. Cl. CPC F16D 48/06; F16D 2500/30412; F16D 2500/7043; F16D 2500/70647; F16D 2500/70668

(57) ABSTRACT

Disclosed is a method for determining a vehicle clutch temperature of a vehicle clutch by a neuron network. The method includes determining at least one input value representing a power supplied to the vehicle clutch, such that the at least one input value is determined on the basis of processing consecutive values of power supplied to the vehicle clutch. At least one input value and at least one value of an operating parameter are input as input data into the neuron network. A clutch temperature is determined by the neuron network on the basis of the input data and of a relationship learned by the neuron network between a time variation of the input data and the clutch temperature. A method is also disclosed for generating a training data set for a neuron network, and a control unit for determining a vehicle clutch temperature using a neuron network.

### RELATED APPLICATIONS

This application claims the benefit under 35 U.S.C. § 371 as a U.S. National Phase Application of application no. PCT/EP2023/064028, filed on 25 May 2023, which claims the benefit of German Patent Application no. 10 2022 205 677.9 filed on 2 Jun. 2022, the contents of which are hereby incorporated herein by reference in their entireties

### TECHNICAL FIELD

The present invention relates to a method for determining a clutch temperature of a vehicle clutch by means of a neural network. The invention also relates to a method for generating a training data set for a neural network which is designed to determine a clutch temperature of a vehicle clutch. Furthermore, the invention relates to an associated control unit for determining a clutch temperature of a vehicle clutch by means of a neural network.

### BACKGROUND

The temperature of a vehicle clutch can be calculated by means of a classical rule-based mathematical model. The calculation can take place in a transmission control unit. For that purpose, machine learning can be used, for example a neural network. Until now, non-linear and structurally complex neuron networks have been used to determine the clutch temperature. for example so-termed folded neural networks.

### SUMMARY

A first aspect the invention relates to a method for determining a clutch temperature of a vehicle clutch by means of a neuron network.

The vehicle clutch can be installed in a motor-driven vehicle such as a motor vehicle, a motorcycle, or an at least partially electrically powered bicycle. By way of the vehicle clutch, a driving force generated by the motor of the vehicle can be transmitted to a drive axle of the vehicle. The vehicle clutch can have at least two different switching conditions or gears, which can be defined by a predetermined ratio between the drive output torque of the motor and the drive input torque of the drive axle.

A clutch temperature can be understood to mean the temperature of at least one clutch element, such as the temperature of a clutch disk. Alternatively, a clutch temperature can also be understood to mean a temperature of the clutch as a whole, which for example can be based on determining an average value of the individual temperatures of the clutch elements. During the operation of the vehicle the temperature of the vehicle clutch can change. For example, during a shifting process or gearshift the temperature of the vehicle clutch can increase. If the temperature of the vehicle clutch rises above a critical temperature value, this can result in damage to or failure of the vehicle clutch. Accordingly, determining a clutch temperature of the vehicle clutch contributes toward the safety of the vehicle.

A neuron network can be understood to mean a mathematical model that at least partially reproduces the structure of the neurons in the human brain. The neuron network can be created with the help of a computer. The neuron network can comprise input nodes. output nodes and a plurality of intermediate nodes arranged between the input nodes and the output nodes. The input nodes can be, for example, data interfaces by way of which input data can be inputted into the neuron network. The output nodes can be, for example, data interfaces by way of which output data can be emitted from the neuron network. The input nodes can be connected to the intermediate nodes and the intermediate nodes can be connected to one another. The intermediate nodes can be connected to the output nodes. The input data can be historical data determined at a specific time. Alternatively, or in addition, the input data can be synthetic data generated by the processing of determined or measured data. Analogously, the output data can be historical data or synthetic data.

At the intermediate nodes information can be at least temporarily stored intermediately. It can be provided that at least one computational operation is carried out at the intermediate nodes. The input data can be transmitted from the input nodes to the output nodes via the intermediate nodes. During this transmission the input data can be mathematically processed, for example converted into the output data. The intermediate nodes of the neuron network can be arranged in one or more layers or planes. The intermediate nodes can be connected to one another within a layer. Furthermore, the intermediate nodes of one layer can be connected to the intermediate nodes of other lavers. The individual connections of the input nodes, the intermediate nodes and the output nodes can be assigned mathematical weightings. Depending on the purpose of the neuron network, the weightings of the connections can be different. During the training of the neuron network the weightings can be changed. By adapting the mathematical weightings of the connections of the individual nodes during the training, a relationship between the input data and the output data can be learned by the neuron network. During the use of the neuron network for the purpose envisaged, the relationship learned by the neuron network can be applied to input data received in order to generate output data in accordance with the specified application purpose of the neuron network

To determine a clutch temperature, for example, a multi-layer-perception (MLP) neuron network can be used. This neuron network comprises at least one layer of intermediate nodes and uses for calculation the output data of at least one non-linear mathematical function. A further example of a neuron network for determining a clutch temperature can be a Fully Connected Layer (FCL) network. In that neuron network all the input nodes, intermediate nodes, and output nodes are connected to one another. In addition. to determine a clutch temperature, for example, a Convolutional Neural Network (CNN) can be used, in which the intermediate nodes of different lavers are connected to one another, at least in the form of a mathematical convolution function.

The method comprises a step of determining at least one input value, which is representative of a power supplied to the vehicle clutch. The at least one input value is determined on the basis of a processing of consecutive values for the power supplied to the vehicle clutch. The power supplied to the vehicle clutch can be understood to mean a physical power, i.e., a quantity of energy, which is supplied to the vehicle clutch during a predetermined time period. For example, the power supplied to the vehicle clutch can be a shifting power supplied during a shifting process or gearshift in the clutch. The power supplied to the vehicle clutch can be representative of a change of the temperature of the vehicle clutch.

The power supplied to the vehicle clutch can be determined at certain time intervals. For example, the individual values of the power supplied to the vehicle clutch can be arranged in ascending sequence in accordance with the time point when they are determined. These consecutive values of the power supplied to the vehicle clutch can be processed mathematically, for example by means of a predetermined computing operation such as the formation of an average value.

Further, the method comprises the step of inputting the at least one input value as input data into the neuron network. For example, the at least one input value can be sent via an input device to at least one of the input nodes of the neuron network. Alternatively, the at least one input value can be transmitted by a control unit of the vehicle via a data interface to at least one of the input nodes of the neuron network. The at least one input value can be used by the neuron network as input data for the determination of the clutch temperature. Alternatively, or in addition, the at least one input value can be used as input data for the training of the neuron network.

Furthermore, the method comprises the step of inputting at least one value of at least one operating parameter of the vehicle clutch as input data into the neuron network. The at least one value of the at least one operating parameter of the vehicle clutch can be representative of a power supplied to the vehicle clutch. Alternatively, or in addition, the at least one value of the at least one operating parameter of the vehicle clutch can be representative of a clutch temperature of the vehicle clutch. The at least one value of the at least one operating parameter can for example be transmitted by means of an input device to at least one of the input nodes of the neuron network. Alternatively, the at least one value of the at least one operating parameter can be transmitted to at least one of the input nodes via a data interface by a control unit of the vehicle. The at least one value of the at least one operating parameter can be used as input data for use by the neuron network to determine the clutch temperature. Alternatively, or in addition, the at least one value of the at least one operating parameter can be used as input data for training the neuron network.

In addition, the method comprises the step of determining a clutch temperature by the neuron network. The neuron network determines the clutch temperature on the basis of the input data and a relationship learned by the neuron network between a variation over time of the input data and the temperature of the clutch. For example, the input data can be processed by the neuron network at the intermediate nodes in accordance with the learned relationship in order to determine the clutch temperature. While learning the relationship, the mathematical weighting of the connections of the individual nodes can be changed by the neuron network in order to determine the clutch temperature. The clutch temperature determined by the neuron network can be used by other components of the vehicle's control system. For example, with the clutch temperature determined a control value can be generated for a control unit of the vehicle, such as a transmission control unit of an automatic transmission. Moreover, the control value can be shown on a display unit of the vehicle. Alternatively, or in addition, the control value based on the clutch temperature can be processed by an evaluation unit which serves, for example, to monitor the driving safety of the vehicle.

The method proposed enables a clutch temperature to be determined by means of a neuron network. Accordingly, the use of classical mathematical models can be dispensed with, which models are generally very complex and therefore time-consuming. Thus, by using a neuron network, on the one hand the computation time required for the clutch temperature can be reduced. Furthermore, the determination of the clutch temperature is based on a variation of the input data over time. Accordingly, a change of the input data with time can also be taken into account by the neuron network. For example, a cooling or heating phase of the vehicle clutch can be detected and taken into account in the determination of the clutch temperature Moreover, for example, the exceeding of a limit value of the clutch temperature or a deviation from normal behavior of the clutch temperature during the cooling or heating phase can be taken into account. Consequently, the clutch temperature can also be determined more precisely by the neuron network. Furthermore, the time variation of the input data is not determined by the neuron network itself, but rather, is only transmitted in the form of the processed input value. The computational effort required for the determination of the clutch temperature is reduced thereby. Thus, the structure of the neuron network can be made less complex. The storage space required for the neuron network can therefore also be reduced.

According to an embodiment, the at least one input value is determined by means of a detection device which determines the values consecutive in time of the power supplied to the vehicle clutch. The detection device can be a device designed to receive and process electrical signals. The detection device can provide the values of the power supplied to the vehicle clutch with respective time information that can represent a detection time-point for each value. By virtue of the time information the values detected can be arranged in a time sequence. The detection device can store the detected values of the power supplied to the vehicle clutch intermediately. Alternatively, the detection device can transmit the detected values of the power supplied to the vehicle clutch to a control unit of the vehicle, in which the processing of the values detected for determining the at least one input value can be carried out. A detection device is a particularly simple means for obtaining values consecutive in time for the power supplied to the vehicle clutch.

In a further embodiment, the consecutive values of the power supplied to the vehicle clutch are detected from a predetermined starting time-point until the time-point when the input data are inputted into the neuron network. The detection and sequencing in time of the values of the power supplied to the vehicle clutch can be done by the at least one detection device. Alternatively, the values of the power supplied to the vehicle clutch can be detected and sequenced in time by some other means. The starting time-point can be specified by a user, for example a driver of the vehicle. Alternatively, the starting time-point can be set by the manufacturer of the vehicle. The starting time-point can be chosen arbitrarily The inputting time of the input data can be the moment at which the at least one input value is inputted into the neuron network. Alternatively, or in addition, the inputting time-point can be the moment at which the at least one value of the at least one operating parameter is inputted into the neuron network. By specifying the starting time-point for the detection of the consecutive values of the power supplied to the vehicle clutch, the method for determining the clutch temperature can be adapted for various types of vehicle clutches or various operating conditions of the vehicle.

According to a further embodiment, the processing of the consecutive values of the power supplied to the vehicle clutch includes the determination of an average value of the power supplied to the vehicle clutch. An average value of the power supplied to the vehicle clutch can for example be understood to mean an arithmetical average, a geometric average or a quadratic average. For the determination of the average value, all the consecutive values available at the time of determination are taken into account. Alternatively, for the determination of the average value only some of the consecutive values of the power supplied to the vehicle clutch are taken into account. The average value can be determined by a detection device which detects the consecutive values of the power supplied to the vehicle clutch. Alternatively, the average value can be determined by a control unit of the vehicle to which the consecutive values of the power supplied to the vehicle clutch are transmitted. The determination of an average value is a simple computing operation with which, moreover, in particular when considered from a statistical standpoint, a relationship between the individual values of the power supplied to the vehicle clutch can be determined.

According to a further embodiment, a plurality of detection devices for determining the consecutive values of the power supplied to the vehicle clutch are provided. For each of the detection devices a different starting time-point for the detection is determined. For example, one detection device can be provided for a long-term detection of values of the power supplied to the vehicle clutch. For the long-term detection, at long time intervals such as 1 minute, 5 minutes, 10 minutes or 30 minutes apart, respective values of the power supplied to the vehicle clutch can be detected. Another detection device can be provided for short-term detection of values of the power supplied to the vehicle clutch. For the short-term detection, at short time intervals, such as 1 second, 100 ms, or 10 ms, a respective value of the power supplied to the vehicle clutch can be detected. For each detection device an input value can be determined by processing the detected value of the power supplied to the vehicle clutch. In this case, for example, an input value for a long-term detection of the values of the power supplied to the vehicle clutch and a further input value for a short-term detection of the values of the power supplied to the vehicle clutch can be determined. Thus, the time variation of the power supplied to the vehicle clutch can be determined in detail and taken into account by the neuron network when determining the clutch temperature.

In a further embodiment, the at least one detection device is chosen from at least one of the following: a control unit designed for data detection, a low-pass filter and an operational amplifier. A low-pass filter can be understood to mean an electronic unit for signal processing. Data in the form of electrical signals can be picked up over a certain time period. For example, a low-pass filter can be an electronic component for signal processing, which signals have a frequency below a frequency limit, and can pass them on virtually unchanged. Signals whose frequency is above the frequency limit are passed on by the low-pass filter with their amplitude damped.

An operational amplifier can be understood to be an electronic unit for signal processing, by means of which data in the form of electrical signals can be picked up over a certain time period. For example, an operational amplifier can be an electronic component for signal processing which reinforces the amplitude of incoming signals and can pass them on. For example, the amplitudes of a number of signals entering the operational amplifier can be summed. In that case an electrical signal can be emitted by the operational amplifier, whose amplitude corresponds to the sum of the amplitudes of the input signals. By summing the amplitudes of a plurality of input signals, a time delay in the passing on of these signals can be achieved. A low-pass filter and an operational amplifier are thus readily obtainable and easily incorporated electronic components for signal processing, with which a time delay of the signals entering those components can be achieved.

According to a further embodiment, the at least one operating parameter of the vehicle clutch is chosen from at least one of the following: a torque of a driveshaft of a drive motor which is mechanically functionally connected to the vehicle clutch; a rotation speed difference between two rotating clutch elements of the vehicle clutch; a rotation speed of a rotating clutch element of the vehicle clutch; a mechanical pressure acting upon a clutch element of the vehicle clutch; a current strength of an electric current flowing through a clutch element of the vehicle clutch; and a sump temperature of a vehicle transmission at the beginning of a shifting process of the vehicle clutch. Clutch elements of the vehicle clutch can be, for example, the clutch disks of a vehicle clutch which can be connected in order to transmit power from the motor to the drive axle. The above parameters can be representative of a power supplied to the vehicle clutch. Alternatively, or in addition, the above parameters can be representative of a clutch temperature of the vehicle clutch. Thus, by using at least one of these parameters the determination of the clutch temperature can be made easier.

A second aspect of the invention relates to a method for generating a training data set for a neuron network which is designed to determine a clutch temperature of a vehicle clutch. The method comprises the following steps: providing a plurality of values consecutive in time of a power supplied to the vehicle clutch, processing the consecutive values provided in order to determine an input value which is representative of the power supplied to the vehicle clutch: providing at least one value of at least one operating parameter of the vehicle clutch; and providing values of a clutch temperature. The training data set contains the input value and the value of the at least one operating parameter as input data, and the values of the clutch temperature as output data. By means of the training data set the neuron network can learn a relationship between a time variation of the input data and the clutch temperature.

The values of the power supplied to the vehicle clutch, the at least one value of the at least one operating parameter of the vehicle clutch and the values of the clutch temperature can be detected by means of devices designed for the purpose of processing electrical signals. The processing of the values provided for the power supplied to the vehicle clutch can be done by a device for electrical signal processing designed for the purpose. The detected and processed values can be sent to an input device for inputting input data into the neuron network. Alternatively, the detected and processed values can be transmitted from the device designed for the purpose, via a data interface, to the input nodes of the neuron network. Alternatively, or in addition, the input data and the output data may be present as synthetic data which can be produced by converting detected or determined data.

The neuron network according to the method of the first aspect can be trained with a training data set generated in accordance with the method of the second aspect. In that way the advantages of both aspects can be combined.

A third aspect of the invention relates to a control unit for determining a clutch temperature of a vehicle clutch. The control unit comprises a computer-readable storage medium on which a neuron network for determining the clutch temperature is stored. In addition, the control unit comprises at least one detection device which detects values consecutive in time of a power supplied to the vehicle clutch. Furthermore, the control unit comprises a determination device for determining at least one input value which is representative of the power supplied to the vehicle clutch. The at least one input value is based on a processing of the consecutive values of the power supplied to the vehicle clutch, detected by the detection device. The control unit also comprises an input device for the inputting of input data into the neuron network. The input data contain the at least one input value and at least one value of at least one operating parameter of the vehicle clutch. Furthermore, the control unit comprises an output device for emitting the clutch temperature determined by the neuron network.

According to the third aspect the devices of the control unit can be designed to receive, process and pass on electrical signals. According to the third aspect the devices of the control unit can be designed to carry out the method according to the first aspect and/or the second aspect. Analogously, the method according to the first aspect or the second aspect can be carried out by the control unit according to the third aspect. The embodiments explained with reference to the first aspect or the second aspect, their technical effects and advantages, also apply analogously to the control unit according to the third aspect.

### BRIEF DESCRIPTION OF THE DRAWINGS

FIG. 1: A flow chart with steps of a method for determining a clutch temperature of a vehicle clutch by means of a neuron network, according to an embodiment of the invention.

FIG. 2: A flow chart with steps of a method for generating a training data set for a neuron network which is designed to determine a clutch temperature of a vehicle clutch. according to a further embodiment of the invention.

FIG. 3: A schematic illustration of a control unit for determining a clutch temperature of a vehicle clutch by means of a neuron network, according to a further embodiment of the invention.

### DETAILED DESCRIPTION OF EMBODIMENTS

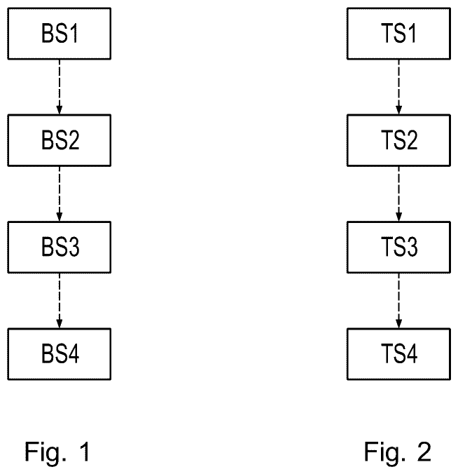

FIG. 1 shows a flow chart with steps of a method for determining a clutch temperature of a vehicle clutch by means of a neuron network, according to an embodiment of the invention.

In a first determination step BS1 at least one input value is determined, which is representative of a power supplied to the vehicle clutch. The at least one input value is determined on the basis of the processing of consecutive values of the power supplied to the vehicle clutch. In the example embodiment of FIG. 1 the power supplied to the vehicle clutch is the shifting power supplied during a shifting process or gearshift of the vehicle clutch.

The values of the shifting power are detected by means of a detection device such as a low-pass filter. The detection takes place from a predetermined starting time-point until the inputting time-point of the input data into the neuron network. The values of the shifting power detected are provided with a time information and arranged in a time sequence on the basis of the time information. The consecutive values of the shifting power are processed in order to determine an average value for the shifting power.

In a second determination step BS2 the at least one input value is inputted into the neuron network as input data. The at least one input value is sent to at least one input node of the neuron network.

In a third determination step BS3 at least one value of at least one operating parameter of the vehicle clutch is inputted as input data into the neuron network. The at least one value of the at least one operating parameter is sent to at least one input node of the neuron network.

In a fourth determination step BS4 a clutch temperature is determined by the neuron network. The clutch temperature is determined on the basis of the input data and a relationship, learned by the neuron network, between a time variation of the input data and the clutch temperature.

To determine the clutch temperature, the input data sent to the input nodes of the neuron network are transmitted by way of connections to intermediate nodes mathematically weighted by the neuron network. At the intermediate nodes the transmitted input data are processed and sent to output nodes of the neuron network by way of connections mathematically weighted by the neuron network. The mathematical weighting of the respective connections will have been adapted by the neuron network during a training process of the neuron network, based on a training data set, that took place prior to the determination process. At least at one output node of the neuron network, when the method has been carried out in full there is a value of the clutch temperature.

By virtue of the determination of the at least one input value a time variation of the shifting power is taken into account when determining the clutch temperature. However, since the time variation is not determined by the neuron network itself but is only communicated to it, the computational effort required by the neuron network for determining the clutch temperature can be kept small. Thus, the neuron network can be made less complex. Likewise, the storage capacity required by the neuron network can also be kept small.

FIG. 2 shows a flow chart with steps of a method for generating a training data set for a neuron network which is designed to determine a clutch temperature of a vehicle clutch in accordance with a further embodiment of the invention.

In a first training step TS1 a plurality of values consecutive in time of a power supplied to the vehicle clutch are produced. These values are detected by a detection device such as a low-pass filter or an operational amplifier. The detection of values of a power supplied to the vehicle clutch can be done analogously to the procedure in the example embodiment of FIG. 1. In the example embodiment of FIG. 2 the power supplied to the vehicle clutch is again the shifting power supplied during a shifting process or gearshift.

In a second training step TS2 the time-consecutive values of the shifting power produced are processed in order to determine an input value that represents the shifting power. In the example embodiment of FIG. 2 the processing of the consecutive values of the shifting power takes place analogously to the determination of an average value of the shifting power in the example embodiment of FIG. 1.

In a third training step TS3 at least one value of at least one operating parameter of the vehicle clutch is provided. This value is representative of a clutch temperature of the vehicle clutch and is transmitted to at least one input node of the neuron network.

In a fourth training step TS4 values of a cutch temperature are produced. These values are measured values of the clutch temperature. In an example embodiment (not shown) the values of the clutch temperature are produced synthetically. The values are transmitted to at least one output node of the neuron network.

The training data set produced consists of the input value and the at least one value of the at least one operating parameter as input data, and the values of a clutch temperature as output data.

The training data set generated in accordance with the embodiment of FIG. 2 can be used for the training of the neuron network in accordance with the embodiment of FIG. 1.

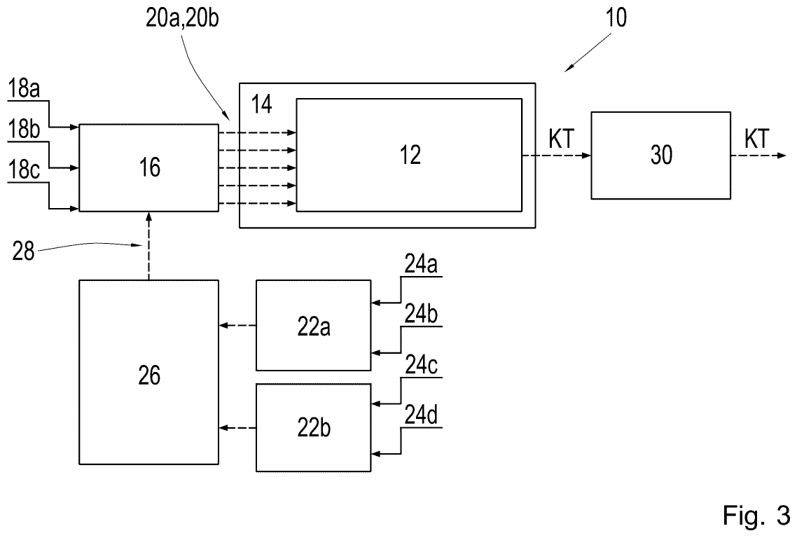

FIG. 3 is a schematic representation of a control unit 10 for determining a clutch temperature of a vehicle clutch (not shown) by means of a neuron network 12 in accordance with a further embodiment of the invention.

The control unit 10 comprises a computer-readable storage medium 14 on which the neuron network 12 is stored. Furthermore, the control unit 10 comprises an input device 16 which is designed to receive values 18a, 18b, 18c of operating parameters of the vehicle clutch. The input device 16 sends the values 18a, 18b, 18c of the operating parameters of the vehicle clutch as input data 20a to the neuron network 12.

The control unit 10 also comprises detection devices 22a, 22b which detect values 24a. 24b and 24c. 24d consecutive in time, of a power supplied to the vehicle clutch. Analogously to the embodiments of FIGS. 1 and 2, the detection device 22a. 22b is a low-pass filter and the values 24a, 24b, 24c, 24d are values of a power supplied to the vehicle clutch as shifting power during a shifting process or gearshift. The values 24a. 24b, 24c, 24d of the shifting power are transmitted by the detection device 22a, 22b to a determination device 26. By processing the consecutive values 24a, 24b, 24c, 24d the determination device 26 determines at least one average value of the shifting power. The at least one average value of the shifting power is sent by the determination device 26 to the input device 16 as an input value 28. The input device 16 transmits the input value 28 as input data 20b to the neuron network 12.

From the input data 20a, 20b the neuron network 12 determines a clutch temperature KT of the vehicle clutch. The clutch temperature KT determined is sent by the neuron network 12 to an output device 30. The output device 30 can send the clutch temperature KT determined to other devices of the vehicle control system.

### INDEXES

10 Control unit
12 Neuron network
14 Storage medium
16 Input device
18a, 18b, 18c Values of operating parameters
22a, 22b Detection devices
24a, 24b, and
24c, 24d Consecutive values of a power supplied to the vehicle clutch
26 Determination device
28 Input value
30 Output device
KT Clutch temperature
BS1 First determination step
BS2 Second determination step
BS3 Third determination step
BS4 Fourth determination step
TS1 First training step
TS2 Second training step
TS3 Third training step
TS4 Fourth training step

1. A method for determining a clutch temperature (KT) of a vehicle clutch by means of a neuron network (12), wherein the method comprises the following steps:
determining (BS1) at least one input value (28) that represents a power supplied to the vehicle clutch, wherein the at least one input value (28) is determined on the basis of processing values (24a, 24b, 24c, 24d) consecutive in time, of the power supplied to the vehicle clutch;
inputting (BS2) the at least one input value (28) as input data into the neuron network (12);
inputting (BS3) at least one value (18a, 18b, 18c) of at least one operating parameter of the vehicle clutch, as input data into the neuron network (12); and
determining (BS4) a clutch temperature (KT) by the neuron network (12), on the basis of the input data (20a, 20b) and of a relationship learned by the neuron network (12) between a time variation of the input data (20a, 20b) and the clutch temperature (KT).

2. The method according to claim 1, wherein determining (BS1) the at least one input value (28) takes place by means of at least one detection device (22a, 22b) configured to detect the consecutive values (24a, 24b, 24c, 24d) of the power supplied to the vehicle clutch.

3. The method according to claim 2, wherein detecting the consecutive values (24a, 24b, 24c, 24d) of the power supplied to the vehicle clutch takes place from a predetermined starting time-point until the inputting time-point of the input data (20a, 20b) into the neuron network (12).

4. The method according to claim 1, wherein processing the consecutive values (24a, 24b, 24c, 24d) of the power supplied to the vehicle clutch includes determining an average value of the power supplied to the vehicle clutch.

5. The method according to claim 2, comprising providing a plurality of detection devices (22a, 22b) configured for detecting the consecutive values (24a, 24b, 24c, 24d) of the power supplied to the vehicle clutch, and determining, for each at least one detection device (22a, 22b), a different starting time-point for the detection.

6. The method according to claim 2, wherein the at least one detection device (22a, 22b) is chosen from at least one of the following: a control unit designed for data detection, a low-pass filter, and an operational amplifier.

7. The method according to claim 1, wherein the at least one operating parameter of the vehicle clutch is chosen from at least one of the following: a torque of a drive axle of a drive motor which is mechanically functionally connected to the vehicle clutch; a rotation speed difference between two rotating clutch elements of the vehicle clutch; a rotation speed of a rotating clutch element of the vehicle clutch; a mechanical pressure acting upon a clutch element of the vehicle clutch; a current strength of an electrical current flowing through a clutch element of the vehicle clutch; and
a sump temperature of a vehicle transmission at the beginning of a shifting process of the vehicle clutch.

8. A method for generating a training data set for a neuron network (12) configured to determine a clutch temperature (KT) of a vehicle clutch, wherein the method comprises the following steps:
providing (TS1) a number of values (24a, 24b, 24c, 24f) consecutive in time, of a power supplied to the vehicle clutch;
processing (TS2) the consecutive values (24a, 24b, 24c, 24f) in order to determine an input value (28) that represents the power supplied to the vehicle clutch;
providing (TS3) at least one value (18a, 18b, 18c) of at least one-operating parameter of the vehicle cutch; and
providing (TS4) values of a clutch temperature,
wherein the training data set contains the input value (28) and the value (18a, 18b, 18c) of the at least one operating parameter as input data, as well as the values of the clutch temperature as output data.

9. The method according to claim 1, wherein the neuron network (12) has been trained by means of a training data set for a neuron network (12) configured to determine a clutch temperature (KT) of a vehicle clutch generated in accordance with a method comprising:
providing (TS1) a number of values (24a, 24b, 24c, 24f) consecutive in time, of a power supplied to the vehicle clutch;
processing (TS2) the consecutive values (24a, 24b, 24c, 24f) in order to determine an input value (28) that represents the power supplied to the vehicle clutch;
providing (TS3) at least one value (18a, 18b, 18c) of at least one operating parameter of the vehicle cutch; and
providing (TS4) values of a clutch temperature,
wherein the training data set contains the input value (28) and the value (18a, 18b, 18c) of the at least one operating parameter as input data, as well as the values of the clutch temperature as output data.

10. A control device (10) for determining a clutch temperature (KT) of a vehicle clutch, the control device comprising:
a computer-readable storage medium (14) on which a neuron network (12) for determining a clutch temperature (KT) is stored;
at least one detection device (22a, 22b) which detects consecutive values (24a, 24b, 24c, 24d) of a power supplied to the vehicle clutch;
a determination device (26) for determining at least one input value (28) that represents a power supplied to the vehicle clutch, wherein the at least one input value (28) is determined on the basis of the processing of the consecutive values (24a, 24b, 24c, 24d) of a power supplied to the vehicle clutch detected by the detection device;
an input device (16) for inputting input data (20a, 20b) into the neuron network (12), wherein the input data (20a, 20b) include the at least one input value (28) and at least one value (18a, 18b, 8c) of at least one operating parameter of the vehicle clutch; and
an output device (30) for the output of the clutch temperature (KT) determined by the neuron network (12).
